(19) United States
(12) Patent Application Publication
(10) Pub. No.: US 2020/0279378 A1
(43) Pub. Date: Sep. 3, 2020

(54) COLLISION DETERMINATION SERVER, PROGRAM, AND RECORDING MEDIUM

(71) Applicant: TOYOTA JIDOSHA KABUSHIKI KAISHA, Toyota-shi (JP)

(72) Inventors: Yoshihiro OE, Kawasaki-shi (JP); Hirofumi KAMIMARU, Fukuoka-shi (JP)

(73) Assignee: TOYOTA JIDOSHA KABUSHIKI KAISHA, Toyota-shi (JP)

(21) Appl. No.: 16/740,932

(22) Filed: Jan. 13, 2020

(30) Foreign Application Priority Data
Feb. 28, 2019 (JP) 2019-035655

(51) Int. Cl. G06T 7/246

(52) U.S. Cl. CPC G06T 7/248; G06T 2207/30241

(57) ABSTRACT

A collision determination server includes a receiver configured to receive a collision candidate moving image from a moving object, an extraction unit configured to extract a plurality of feature points in a frame image constituting the received collision candidate moving image from the frame image, a generation unit configured to generate trajectory patterns of the feature points by tracking the extracted feature points, and a determination unit configured to determine whether or not a collision has occurred by analyzing the trajectory patterns.

### INCORPORATION BY REFERENCE

The disclosure of Japanese Patent Application No. 2019-035655 filed on Feb. 28, 2019 including the specification, drawings and abstract is incorporated herein by reference in its entirety.

### BACKGROUND

### 1. Technical Field

The disclosure relates to a technique for accurately performing collision determination for a moving object.

### 2. Description of Related Art

A technique, in which an obstacle ahead of is detected by a radar, a driver is warned to perform an avoidance operation in a case where there is a possibility of a collision with an obstacle such as an automobile, and brake control is automatically is performed to reduce damage attributable to the collision with the obstacle in a case where the collision with the obstacle cannot be avoided, is being developed. In addition, a technique in which a situation at the time of occurrence of a collision accident is accurately detected by means of a radar even if the collision accident occurs has been proposed (for example, refer to Japanese Unexamined Patent Application Publication No. 2018-5787 (JP 2018-5787 A)).

### SUMMARY

However, to detect a collision accident by using the radar as described above, a radar sensor needs to be installed in each of traffic signals, display boards, telegraph poles, and the like and each vehicle needs to be provided with a radar accident detection device. Installation or the like of such devices leads to a large cost and it has been pointed out that the installation or the like of such devices is difficult to be realized.

The disclosure provides a technique with which it is possible to quickly and accurately detect occurrence of a collision accident without providing a radar device in a vehicle or main equipment newly.

A first aspect of the disclosure relates to a collision determination server including a receiver, an extraction unit, a generation unit, and a determination unit. The receiver is configured to receive a collision candidate moving image from a moving object. The extraction unit is configured to extract a plurality of feature points in a frame image constituting the received collision candidate moving image from the frame image. The generation unit is configured to generate trajectory patterns of the feature points by tracking the extracted feature points. The determination unit is configured to determine whether or not a collision has occurred by analyzing the trajectory patterns.

A second aspect of the disclosure relates to a collision determination program. The collision determination program causes a computer to function as a receiver configured to receive a collision candidate moving image from a vehicle, an extraction unit configured to extract a plurality of feature points in a frame image constituting the received moving image from the frame image, a generation unit configured to generate trajectory patterns of the feature points by tracking the extracted feature points, and a determination unit configured to determine whether or not a collision has occurred by analyzing the trajectory patterns.

According to the aspects of the disclosure, it is possible to quickly and accurately detect occurrence of a collision accident without providing a radar device in a vehicle or main equipment newly.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration of an information control system according to an embodiment;

FIG. 2 is a block diagram illustrating a functional configuration of a vehicle according to the embodiment;

FIG. 3 is a block diagram illustrating a functional configuration of a drive recorder device according to the embodiment;

FIG. 4 is a block diagram illustrating a functional configuration of a collision determination server according to the embodiment;

FIG. 5 is a diagram illustrating a certain collision candidate moving image and trajectory patterns of feature points that are obtained in a case where the collision candidate moving image is analyzed;

FIG. 6 is a flowchart illustrating a collision determination operation; and

FIG. 7 is a block diagram illustrating a functional configuration of a collision determination server according to a modification example.

### DETAILED DESCRIPTION OF EMBODIMENTS

Hereinafter, an embodiment of the disclosure will be described with reference to drawings. In the following description, the same elements are given the same reference numerals and repetitive description will be omitted.

### A. Embodiment

A-1. Configuration

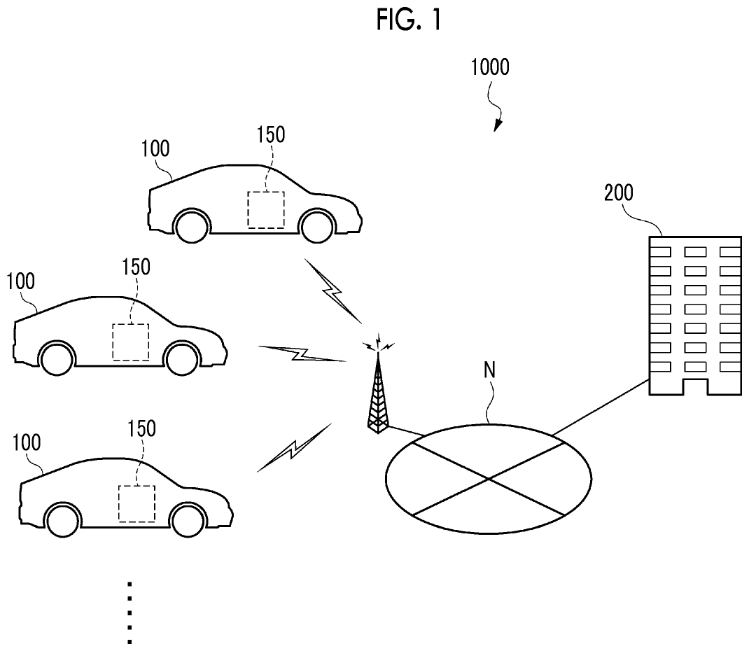

FIG. 1 is a diagram illustrating a schematic configuration of an information control system 1000 according to the embodiment. The information control system 1000 shown in FIG. 1 is configured to be provided with vehicles 100 in which drive recorder devices 150 are installed and a collision determination server 200 that analyzes a collision candidate moving image (which will be described later) uploaded (transmitted) from the drive recorder device 150 of each vehicle 100 and performs collision determination or the like based on the result of the analysis.

The vehicles 100, the drive recorder devices 150, and the collision determination server 200 can communicate with each other via a communication network N. The communication network N may be, for example, any of the internet, a LAN, a dedicated line, a telephone line, an office network, a mobile communication network, Bluetooth (registered trademark), WiFi (wireless fidelity), other communication lines, and a combination thereof and it does not matter whether the communication network N is a wired network or a wireless network.

[Vehicle 100]

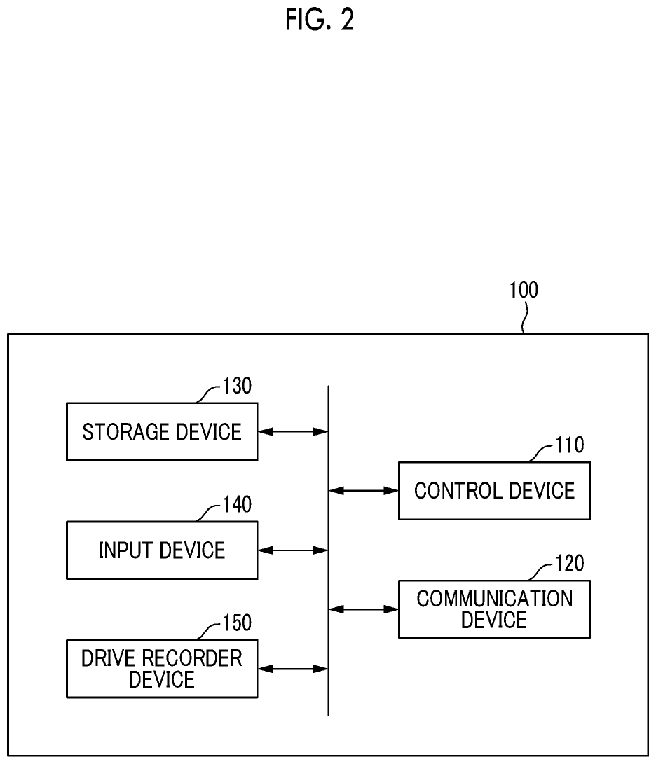

FIG. 2 is a block diagram illustrating a functional configuration of the vehicle 100. The vehicle 100 is an automobile or the like and is provided with a control device 110, a communication device 120, a storage device 130, an input device 140, and the drive recorder device 150.

The control device 110 is provided with a micro control unit (MCU) or the like including a CPU, a ROM, a RAM, and the like as main components and comprehensively controls each part of the vehicle 100 by executing various programs stored in the ROM or the RAM.

The communication device 120 is provided with a communication interface compliant with various communication standards and the communication device 120 gives and receives data to and from an external device such as the collision determination server 200 and a portable terminal (not shown) carried by a user via the communication network N.

The storage device 130 is configured to include a recording medium such as a hard disk and a semiconductor memory and a drive device for the recording medium. A program, data, or the like that is needed when the control device 110 comprehensively controls the vehicle 100 is stored in the storage device 130 such that the program, data, or the like can be updated.

The input device 140 is configured to be provided with an operation element such as an operation key, an operation button, a touch sensor, and the like and a microphone.

The drive recorder device 150 generates a collision candidate moving image under control of the control device 110 and transmits the moving image to the collision determination server 200.

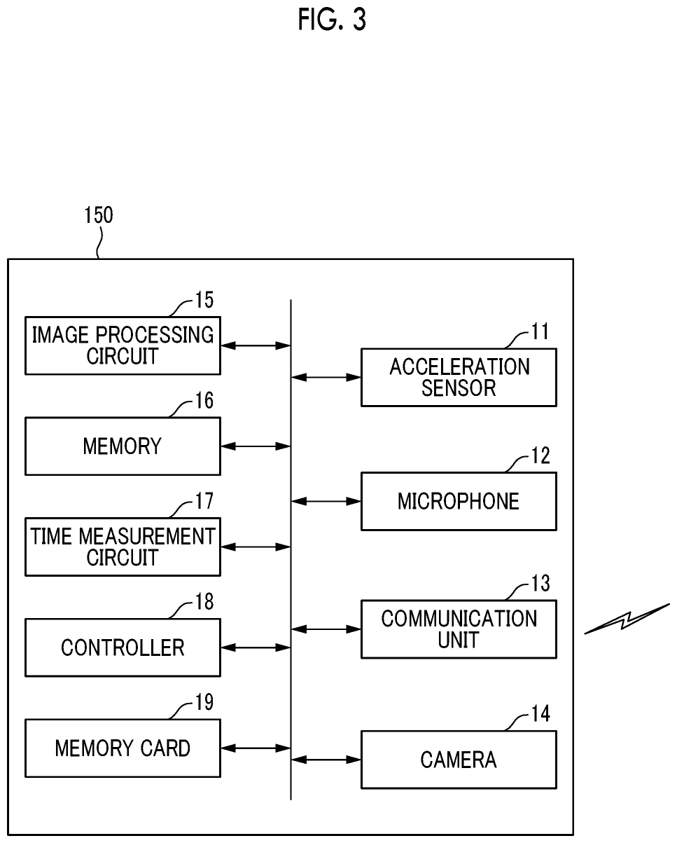

FIG. 3 is a diagram illustrating the configuration of the drive recorder device 150. The drive recorder device 150 is provided with an acceleration sensor 11, a microphone 12, a communication unit 13, a camera 14, an image processing circuit 15, a memory 16, a time measurement circuit 17, a controller 18, and a memory card 19.

The acceleration sensor 11 is an impact sensor (so-called G sensor) that detects an impact acting on the vehicle 100 and measures acceleration showing the magnitude of an impact applied to the vehicle 100 in units of G (gravitational acceleration). The acceleration measured by the acceleration sensor 11 has a magnitude in each of directions corresponding to three axes or two axes orthogonal to each other, for example. The acceleration sensor 11 outputs a signal corresponding to such acceleration (acceleration signal) to the controller 18.

The microphone 12 converts a sound generated in the vicinity of the vehicle 100 into an electric signal and stores the electric signal in the memory 16 in the form of sound data, via a signal processing circuit (not shown).

The communication unit 13 communicates with the collision determination server 200 or the portable terminal carried by the user via the communication network N.

The camera 14 is composed of various image sensors, images the inside or the outside of the vehicle 100, and transmits the result of an operation of imaging of the inside or the outside of the vehicle 100 to the image processing circuit 15 in the form of a video signal. In the present embodiment, the camera 14 is disposed in the vicinity of an upper portion of a windshield and is disposed at a position at which the camera 14 can acquire an image of a region in front of the vehicle 100 (for example, position between rear-view mirror and windshield). For example, and not as a limitation, a sensor of which the number of effective pixels is equal to or larger than two million and the maximum frame rate is equal to or greater than 27.5 fps and that can perform high-quality eight-million-pixel recording (corresponding to 4K) in which the number of recorded pixels is 2880 (horizontal)×2880 (vertical) can be used as each of the image sensors.

The image processing circuit 15 performs analog-to-digital conversion, brightness correction, contrast correction, and the like with respect to the video signal input from the camera 14 to generate image data in a predetermined format (for example, JPEG) and stores the generated image data in the memory 16.

The memory 16 is, for example, a RAM or the like and a part of a storage region thereof is used as a ring buffer. Image data corresponding to a certain time of period processed in the image processing circuit 15 and sound data corresponding to a certain time of period processed in the signal processing circuit are stored in a ring buffer region at all times. Note that, the ring buffer region has such a size that image data and sound data corresponding to several tens of seconds can be stored therein.

The time measurement circuit 17 generates time measurement data indicating the current time and outputs the time measurement data to the controller 18. The time measurement circuit 17 includes, for example, a built-in battery and accurately measures time without receiving electric power supplied from the outside thereof.

The controller 18 generates moving image data from the image data and the sound data recorded in the ring buffer region of the memory 16 and records the moving image data in the memory card 19. Furthermore, when the controller 18 detects that a predetermined event has occurred, the controller 18 reads moving image data before and after the time of the predetermined event from the memory 16 by means of the time measurement circuit 17, assigns a device ID for identification of the drive recorder device 150 of the controller 18 and time measurement information indicating a measured time to the moving image data before and after the time of the predetermined event, and transmits the moving image data before and after the time of the predetermined event, the device ID, and the time measurement information to the collision determination server 200.

Here, the “predetermined event” refers to an event in which acceleration equal to or greater than a predetermined value (for example, 0.4 G) is continuously detected by the acceleration sensor 11 for a predetermined time (for example, 100 milliseconds) or more and will be referred to as a “collision candidate event” below. In addition, a plurality of items of moving image data that the controller 18 transmits to the collision determination server 200 in a case where occurrence of a collision candidate event is detected will be referred to as a “collision candidate moving image”.

[Collision Determination Server 200]

Referring again to FIG. 1, the collision determination server 200 is composed of a computer with a high calculation performance and is provided with a function of accumulating and managing a collision candidate moving image uploaded from the drive recorder device 150 of each vehicle 100, a function of analyzing the collision candidate moving image, and a function of performing collision determination based on the result of the analysis of the collision candidate moving image. Here, the number of computers constituting the collision determination server 200 may not be one and the collision determination server 200 may be composed of a plurality of computers spread on the communication network N.

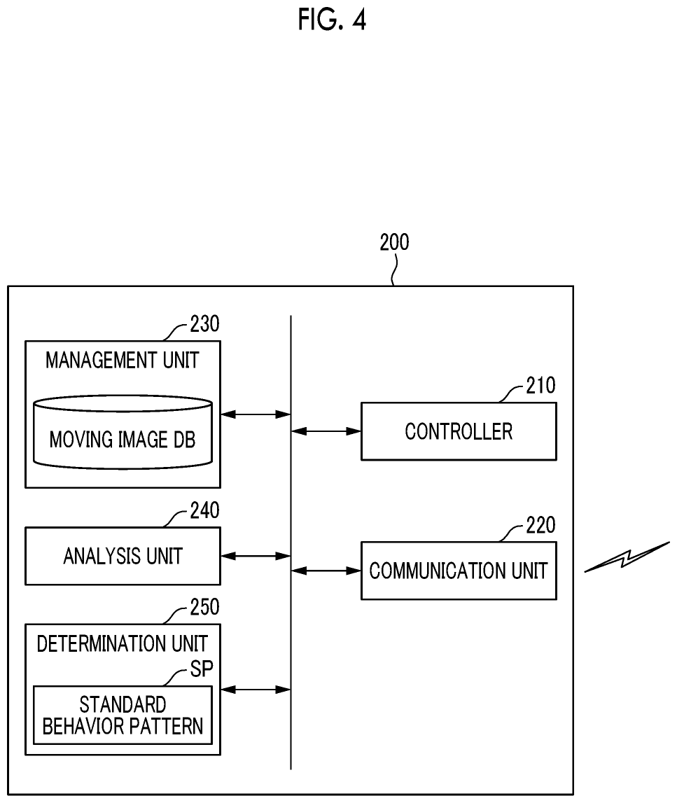

FIG. 4 is a block diagram illustrating a functional configuration of the collision determination server 200. The collision determination server 200 is configured to be provided with a controller 210, a communication unit 220, a management unit 230, an analysis unit 240, and a determination unit 250. The controller 210 is configured to be provided with an arithmetic-logic calculation unit (for example, CPU) processing arithmetic calculation, a logical operation, a bitwise operation, and the like and storage means such as a ROM and a RAM and centrally controls each part of the collision determination server 200 by executing various programs stored in the storage means such as the ROM.

The communication unit (receiver) 220 is provided with a communication interface compliant with various communication standards and receives a collision candidate moving image uploaded from the drive recorder device 150 of the vehicle 100 via the communication network N. Note that, the communication unit 220 gives and receives various items of information to and from an external device including the vehicles 100.

The management unit 230 accumulates and manages the collision candidate moving image from the drive recorder device 150 of each vehicle 100 in a moving image database (DB) in association with a device ID.

The analysis unit (extraction unit, generation unit) 240 cuts a plurality of frame images out of the received collision candidate moving image and extracts N feature points from each frame image (N≥2). As a method of extracting and detecting feature points, for example, a corner detection method can be used. However, another detection method may also be used. When N feature points are extracted from an initial frame (for example, frame in initial stage from among time-series image frames), the analysis unit 240 searches for corresponding points in the subsequent frames to track the N feature points and generates trajectory patterns of the feature points.

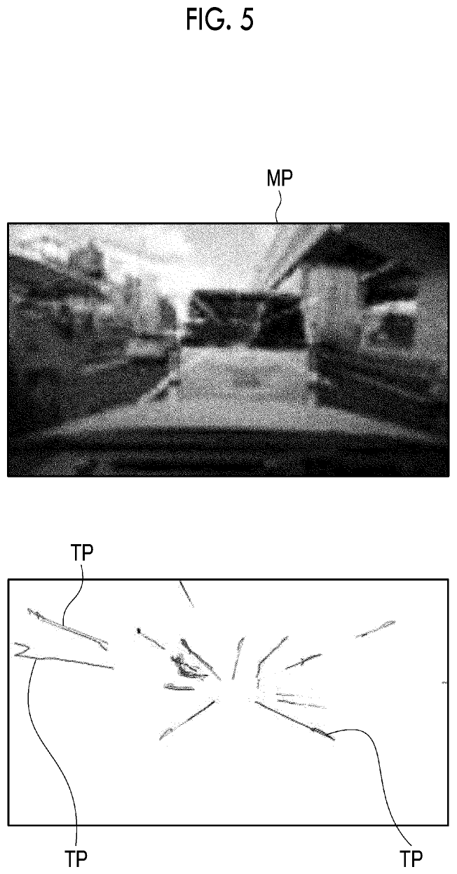

FIG. 5 is a diagram illustrating a certain collision candidate moving image

MP and trajectory patterns TP of feature points that are obtained in a case where the collision candidate moving image MP is analyzed. When the analysis unit 240 generates the trajectory patterns TP of the feature points as shown in FIG. 5, the analysis unit 240 outputs the trajectory patterns TP to the determination unit 250.

The determination unit 250 determines whether or not a collision has occurred by comparing the trajectory patterns TP of the feature points output from the analysis unit 240 with a standard behavior pattern SP held by the determination unit 250. Here, examples of the collision candidate moving image MP include a moving image (collision moving image) transmitted in a case where a brake is suddenly applied without occurrence of a collision accident in addition to a moving image (non-collision moving image) transmitted in a case where a collision accident occurs actually.

In the present embodiment, to quickly and accurately specify a collision moving image from among a plurality of collision candidate moving images, a trajectory pattern of each feature point obtained from an actual collision moving image is learned and determination on whether or not a collision has occurred is performed by using the standard behavior pattern SP generated. Specifically, the determination unit 250 obtains the degree of similarity between the trajectory patterns TP output from the analysis unit 240 and the standard behavior pattern SP, determines that a collision has occurred in a case where the obtained degree of similarity is equal to or greater than a threshold value set, and determines that no collision has occurred in a case where the obtained degree of similarity is smaller than the threshold value.

Then, the determination unit 250 causes a display panel (not shown) or the like to display the result of the determination on whether or not a collision has occurred. Note that, in a case where the determination unit 250 determines that a collision has occurred, the determination unit 250 may notify the outside of a message indicating that a collision moving image has been detected by using a voice, a text, or sound effects while causing the display panel to display the collision moving image.

Hereinafter, a collision determination operation performed by the collision determination server 200 will be described in detail.

A-2. Operation

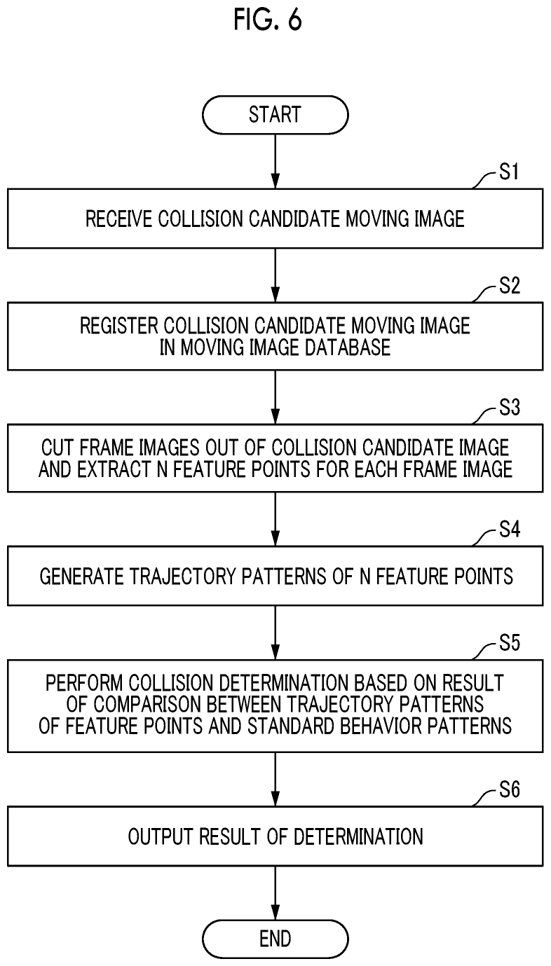

FIG. 6 is a flowchart illustrating the collision determination operation performed by the collision determination server 200.

In step S1, the communication unit 220 of the collision determination server 200 receives a collision candidate moving image uploaded from the drive recorder device 150 of the vehicle 100 via the communication network N.

In step S2, the management unit 230 of the collision determination server 200 registers the received collision candidate moving image in the moving image database DB in association with a device ID of the drive recorder device 150.

In step S3, the analysis unit 240 of the collision determination server 200 cuts a plurality of frame images out of the collision candidate moving image and extracts N feature points for each frame image.

In step S4, when the N feature points are extracted from an initial frame, the analysis unit 240 of the collision determination server 200 tracks the N feature points while advancing frames, generates trajectory patterns TP of the feature points as shown in

FIG. 5, and outputs the trajectory patterns TP to the determination unit 250.

In step S5, the determination unit 250 of the collision determination server 200 determines whether or not a collision has occurred by comparing the trajectory patterns TP of the feature points output from the analysis unit 240 with the standard behavior pattern SP held by the determination unit 250.

In step S6, the determination unit 250 of the collision determination server 200 causes the display panel to display the result of the determination and the process is terminated.

As described above, according to the present embodiment, the collision determination server 200 performs collision determination by extracting and tracking feature points in a collision candidate moving image uploaded from the drive recorder device 150 of the vehicle 100 and analyzing trajectory patterns of the feature points. Therefore, it is possible to quickly and accurately detect occurrence of a collision accident without providing a radar device in a vehicle or main equipment newly.

Note that, in the present embodiment, an event in which acceleration equal to or greater than 0.4 G is continuously detected for 100 milliseconds or more has been described as an example of the “collision candidate event”. However, the disclosure is not limited thereto. The value of acceleration detected, the length of time of continuation, or the like can be randomly set or changed.

### B. Modification Example

In the above-described embodiment, determination on whether or not a collision has occurred is performed based on the result of comparison between trajectory patterns of feature points extracted from a collision candidate moving image and standard patterns. However, the disclosure is not limited thereto. For example, determination on whether or not a collision has occurred may be performed based on the movement acceleration of feature points tracked.

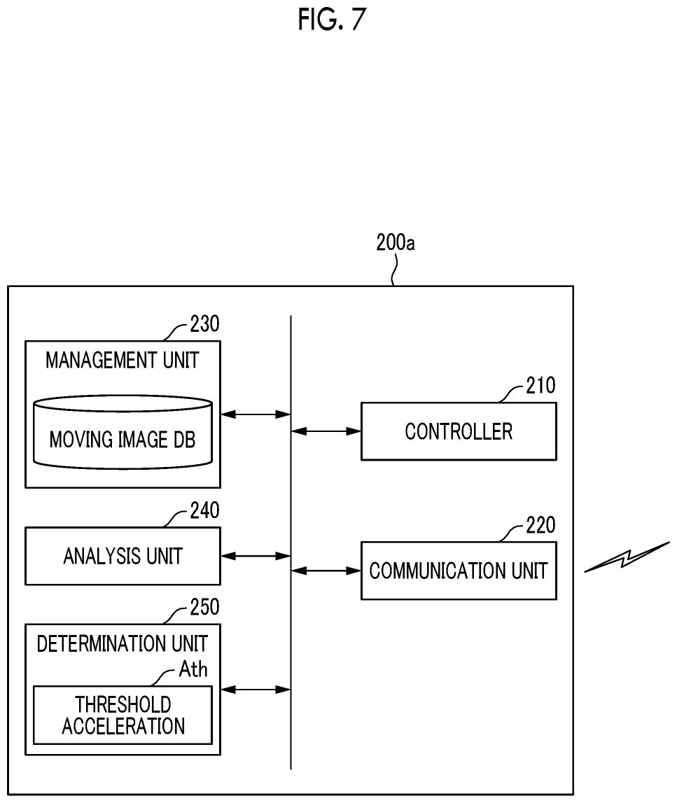

FIG. 7 is a block diagram illustrating a functional configuration of a collision determination server 200a according to a modification example. The functions of a determination unit 250a of the collision determination server 200a shown in FIG. 7 are different from those in the embodiment. The other components are the same as those in the collision determination server 200 shown in FIG. 3. Therefore, corresponding parts are given the same reference numerals and detailed description thereof will be omitted.

The determination unit 250a calculates the movement acceleration of each feature point based on the amount of movement and the speed of each feature point output from the analysis unit 240. For example, in a case where the number of feature points in a specific time is N, the determination unit 250a determines that a feature point out of the N feature points, of which the movement acceleration is considerably different from an average value in a corresponding frame (that is, average movement acceleration), is noise and removes the feature point. Then, the determination unit 250a determines whether or not the movement acceleration after the noise removal is equal to or greater than a set threshold acceleration Ath. The determination unit 250a determines that a collision has occurred in a case where the movement acceleration after the noise removal is equal to or greater than the threshold acceleration Ath and determines that no collision has occurred in a case where the movement acceleration after the noise removal is smaller than the threshold acceleration Ath. Note that, the subsequent operations are the same as those in the embodiment and thus description thereof will be omitted.

### C. Others

The disclosure is not limited to the above-described and the modification example and can be implemented in various other forms without departing from the spirit of the disclosure. Therefore, the above-described embodiment and the modification example are merely examples and are not to be interpreted limitedly. For example, the order in which the processing steps described above are performed can be randomly changed as long as there is no contradiction of the contents of the process. Alternatively, the processing steps can be performed in parallel.

In addition, in the specification, an expression “device” or “unit” does not merely mean a physical component and the meaning thereof also includes a case where a process executed by the “device” or “unit” is realized by means of software. In addition, a process performed by one “device” or “unit” may be realized by two or more physical components and a process performed by two or more “devices” or “units” may be realized by one physical means. In addition, in the above-described embodiment and the modification example, an automobile has been used as an example of the vehicle 100. However, the disclosure can be applied to various moving objects such as a motorcycle, a train, and a ship.

A program for performing the processes described in the specification may be stored in a recording medium. With the recording medium, it is possible to install the above-described program in a computer constituting the collision determination servers 200, 200a. Here, the recording medium storing the program may be a non-transitory recording medium. The non-transitory recording medium is not particularly limited and may be, for example, a recording medium such as a CD-ROM.

What is claimed is:

1. A collision determination server comprising:
a receiver configured to receive a collision candidate moving image from a moving object;
an extraction unit configured to extract a plurality of feature points in a frame image constituting the received collision candidate moving image from the frame image;
a generation unit configured to generate trajectory patterns of the feature points by tracking the extracted feature points; and
a determination unit configured to determine whether or not a collision has occurred by analyzing the trajectory patterns.

2. The collision determination server according to claim 1, wherein the determination unit is provided with a standard behavior pattern for determination on whether or not a collision has occurred and determines whether or not a collision has occurred based on a result of comparison between the trajectory patterns and the standard behavior pattern.

3. The collision determination server according to claim 1, wherein the determination unit calculates movement acceleration of each of the feature points and determines that a collision has occurred in a case where the calculated movement acceleration is equal to or greater than a set threshold value.

4. A collision determination program causing a computer to function as:
a receiver configured to receive a collision candidate moving image from a vehicle;
an extraction unit configured to extract a plurality of feature points in a frame image constituting the received moving image from the frame image;
a generation unit configured to generate trajectory patterns of the feature points by tracking the extracted feature points; and
a determination unit configured to determine whether or not a collision has occurred by analyzing the trajectory patterns.

5. A recording medium on which the collision determination program according to claim 4 is recorded.
